(19) United States
(12) Patent Application Publication
(10) Pub. No.: US 2010/0307425 A1
(43) Pub. Date: Dec. 9, 2010

(54) Collapsible, self-supporting pet enclosure

(75) Inventors: Lisa Illman, Philadelphia, PA (US); Bruce McLellan, Round Rock, TX (US)

Correspondence Address: SCHNADER HARRISON SEGAL & LEWIS, LLP, 1600 MARKET STREET, SUITE 3600, PHILADELPHIA, PA, 19103, US

(73) Assignee: Lisa Illman, Philadelphia, PA (US)

(21) Appl. No.: 12/661,896

(22) Filed: Mar. 25, 2010

Related U.S. Application Data
(60) Provisional application No. 61/163,303, filed on Mar. 25, 2009.

(51) Int. Cl. A01K 1/03

(52) U.S. Cl. 119/499

(57) ABSTRACT

A portable pet cage comprises one or more pieces of mesh supported by a frame comprising a plurality of loops that are rotatably connected together for form a foldable frame. The loops fold into a convenient, generally flat configuration for carrying and then are rotated into spaced, generally perpendicular relation and locked in that position for use.

### CROSS-REFERENCE TO RELATED APPLICATIONS

This application incorporates by reference and claims the priority of U.S. provisional patent application No. 61/163,303, filed Mar. 25, 2009.

### STATEMENT REGARDING FEDERALLY SPONSORED RESEARCH OR DEVELOPMENT

Not applicable.

### FIELD OF THE INVENTION

This invention relates to the field of pet enclosures.

### BACKGROUND OF THE INVENTION

There are several known configurations for collapsible pet enclosures. U.S. Pat. No. 6,688,256 discloses a portable pet enclosure including a mesh supported by a plurality of frame pieces that have prongs for insertion into the ground. U.S. patent application publication no. 2006/0236952A1 discloses a different portable animal enclosure, which includes a ground mat, a plurality of support members, and a roof.

### SUMMARY OF THE INVENTION

The devices disclosed herein include a portable pet enclosure comprising one or more pieces of mesh or netting. The mesh is foldable in the manner of a fabric and preferably is a sturdy, flexible, and relatively open. The mesh is preferably selected to that a pet can see through the mesh and enjoy sunlight but not escape through the mesh holes. Fish netting, golf/sports netting or mosquito netting can be used here, but other mesh, net, or fabric material could be used, provided that it is flexible, sufficiently sturdy to confine a pet, and preferably is translucent. In one embodiment, the mesh is supported by a support frame comprising a plurality of loops and a U-shaped member that are rotatably connected together to form a foldable support frame. The support frame folds into a generally flat configuration for convenient carrying. For use, the loops and the U-shaped member are rotated into spaced, preferably and generally perpendicular relation and locked in that position for use in enclosing an animal. The devices disclosed herein provide a folding frame for a pet enclosure that is superior to prior collapsible pet enclosures using multiple frame pieces with prongs because the devices disclosed herein are easier to set up in a stable configuration. In addition, the devices disclosed herein do not require a floor mat and do not require prongs for insertion into the ground. The devices disclosed herein also are broken down and stored more easily than the prior-art devices because the devices disclosed herein may remain completely assembled and completely connected (except for the removal of locking pins and/or shade frame) after being collapsed.

### DESCRIPTION OF THE DRAWINGS

The invention is best understood from the following detailed description when read with the accompanying drawings.

FIG. 1 shows a perspective view of a pet enclosure according to an illustrative embodiment of the invention, with an entrance door in the open position.

FIG. 2 shows a perspective view of a pet enclosure according to an illustrative embodiment of the invention, with an entrance door in the closed position.

FIG. 3 shows a partial perspective view of a pet enclosure according to an illustrative embodiment of the invention, with an entrance door in the closed position.

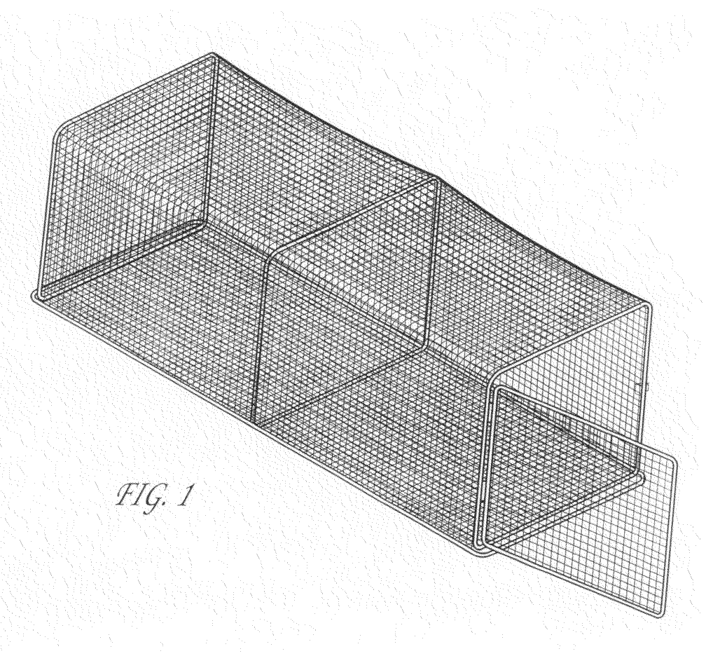

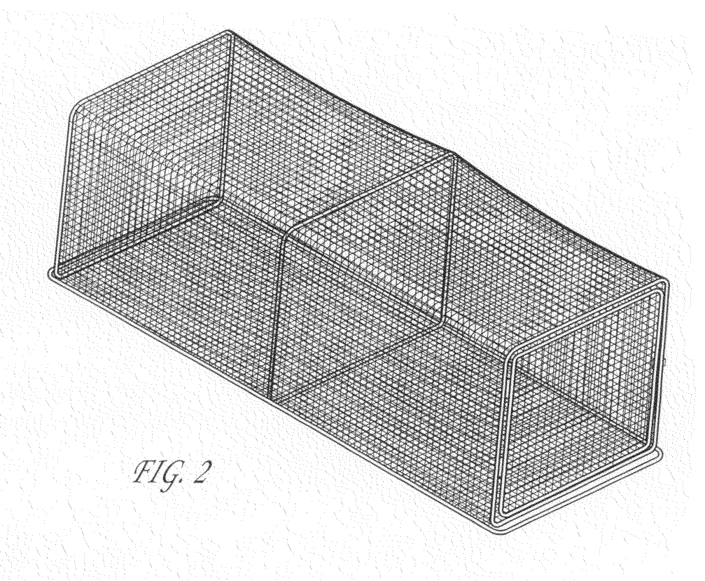

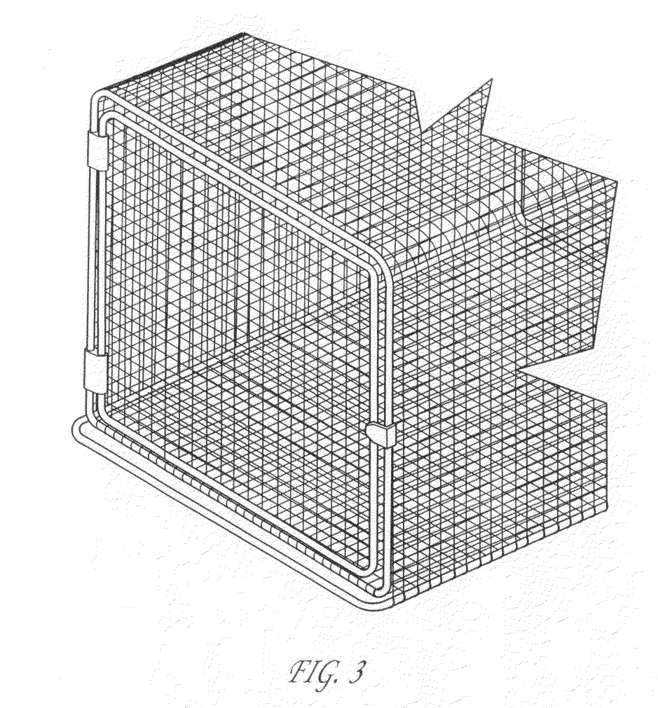

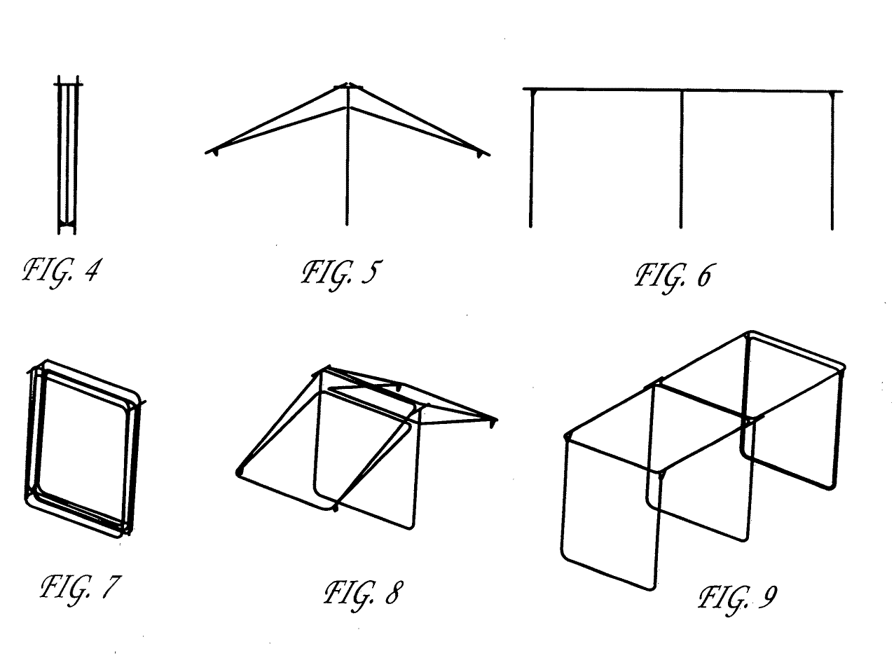

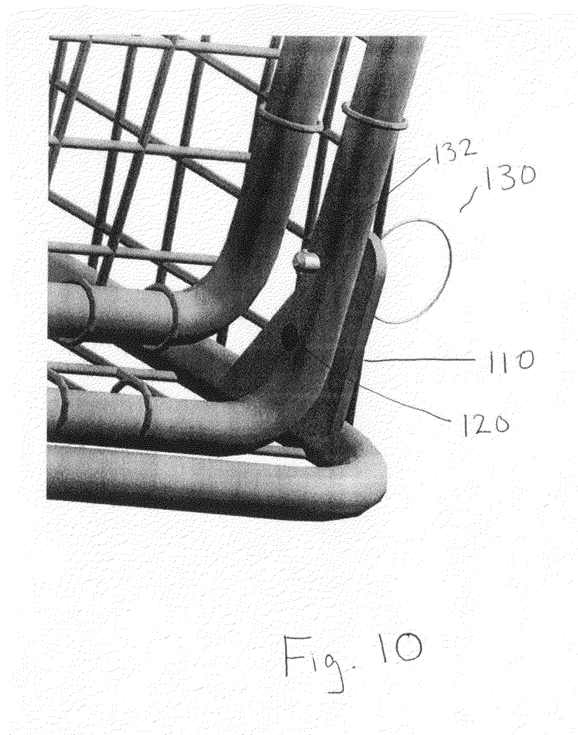

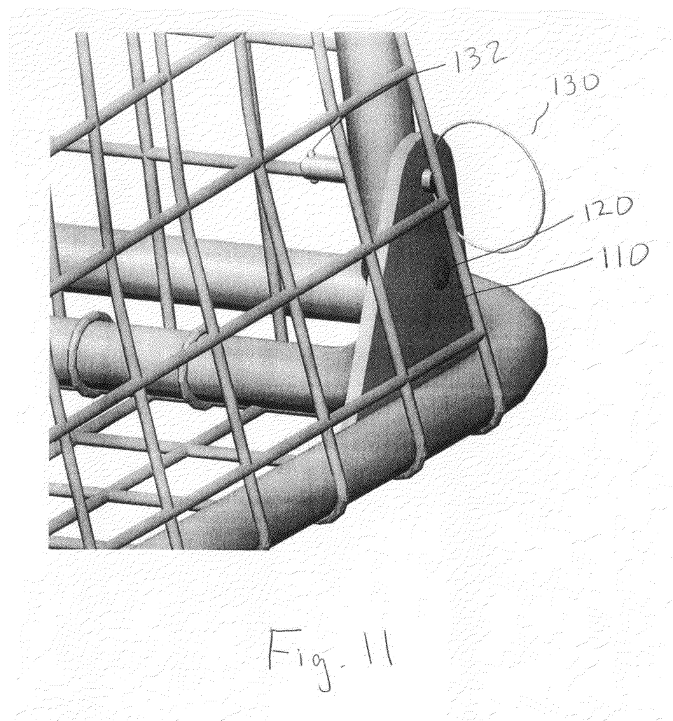

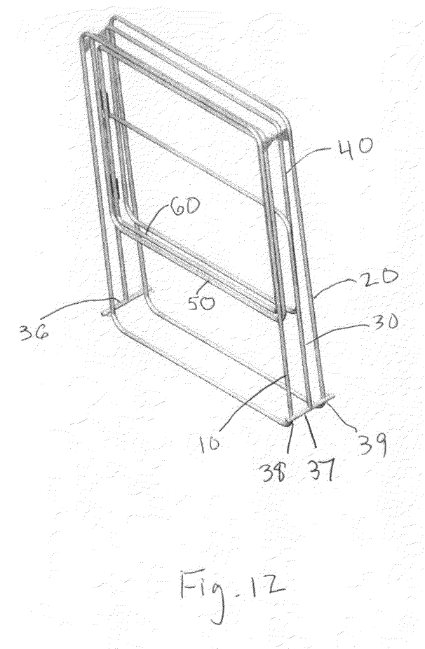

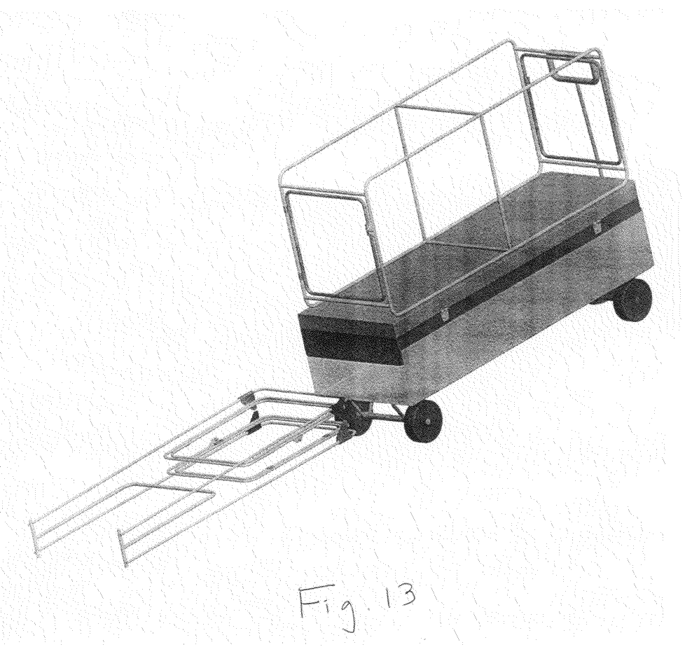

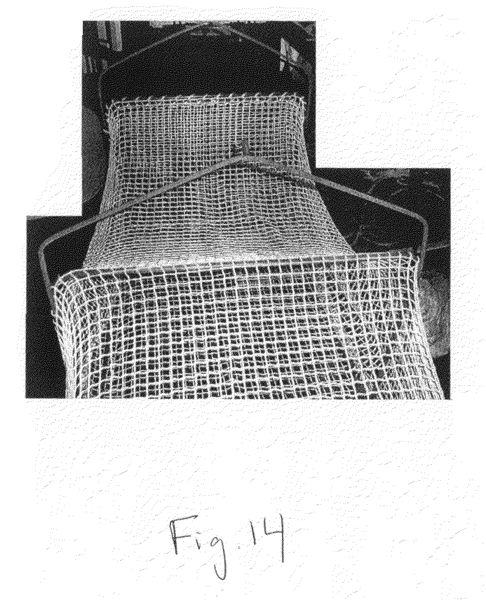

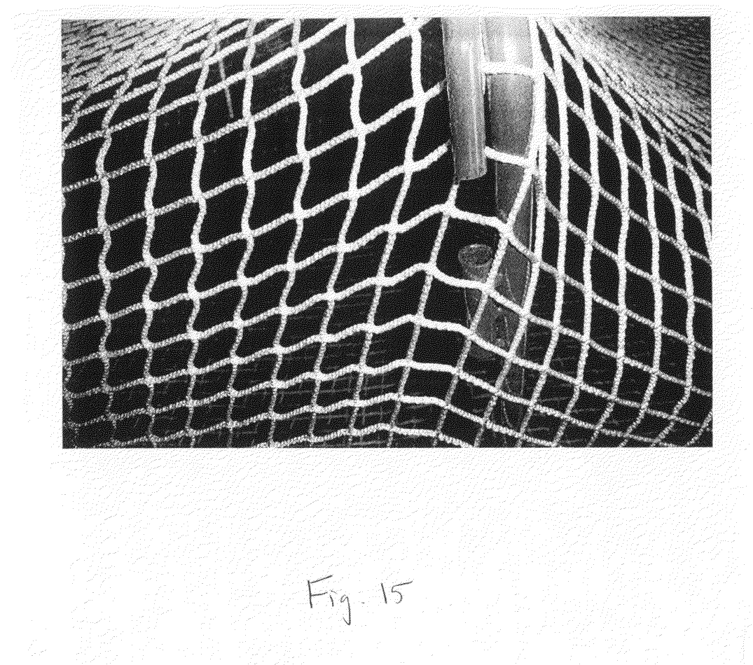

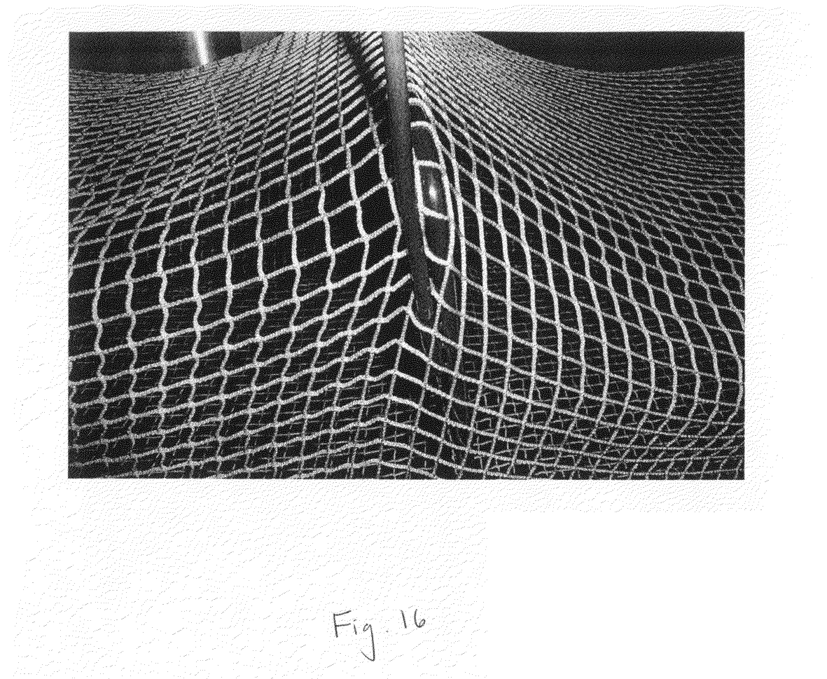

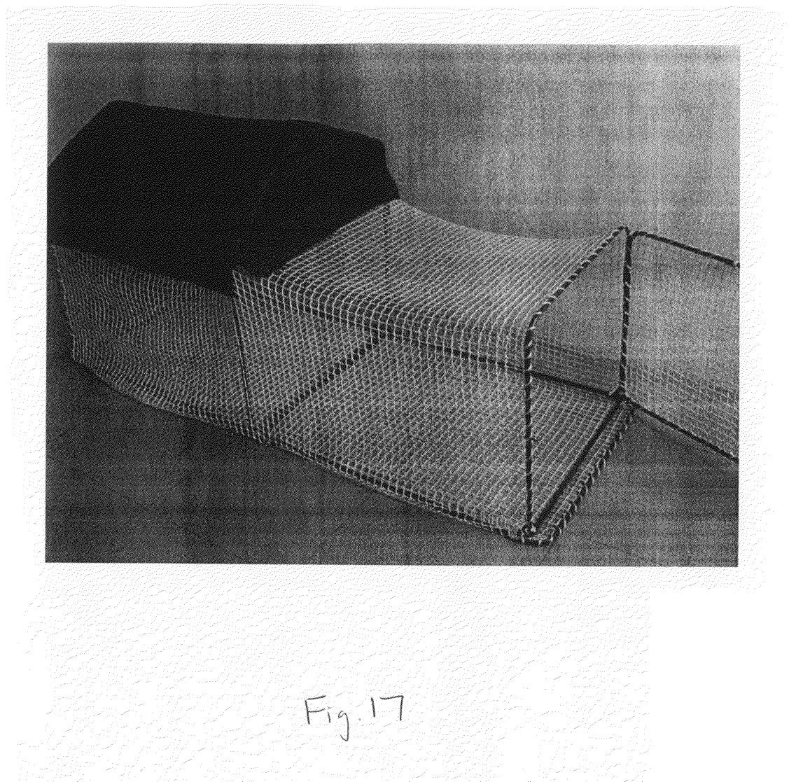

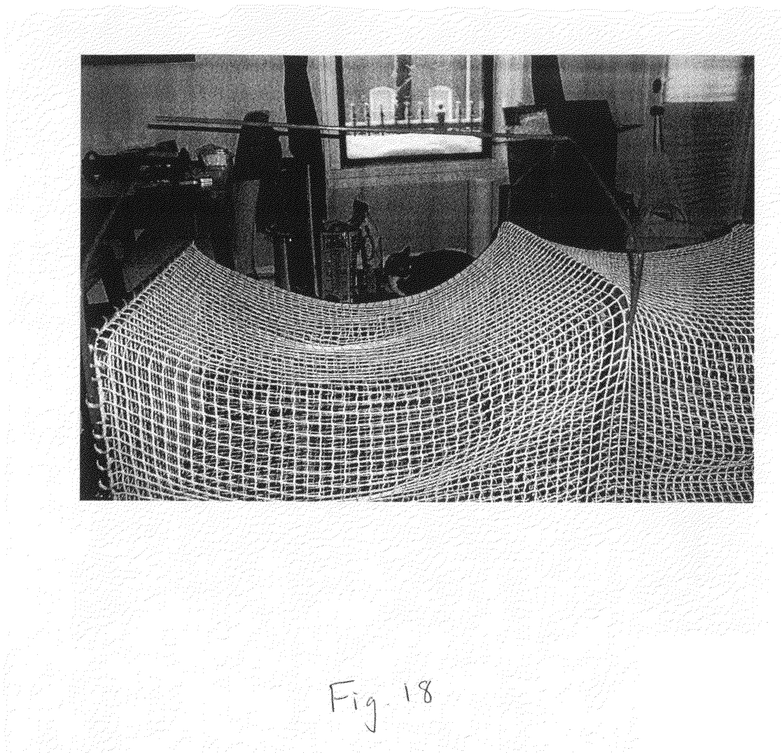

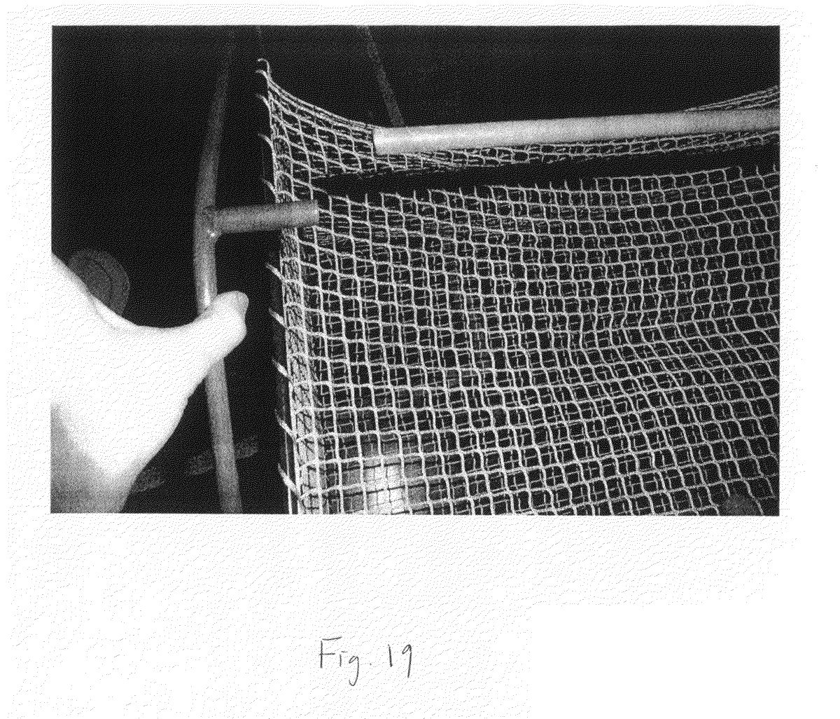

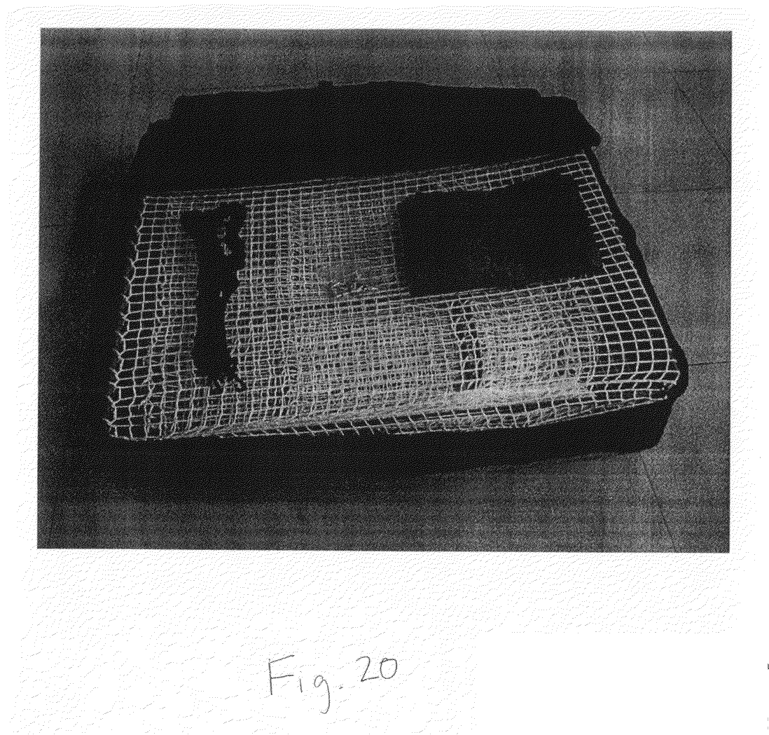

In FIGS. 4-6, only the frame has been shown; for clarity, the mesh has been omitted. FIGS. 4-6 show side views an illustrative embodiment of a pet closure according to the invention. FIG. 4 shows the frame fully collapsed. FIG. 5 shows the frame in an intermediate position between fully collapsed and fully open. FIG. 6 shows the frame fully open.

In FIGS. 7-9, only the frame has been shown; for clarity, the mesh has been omitted. FIGS. 7-9 show perspective views of an illustrative embodiment of a pet closure according to the invention. FIG. 7 shows the frame fully collapsed. FIG. 8 shows the frame in an intermediate position between fully collapsed and fully open. FIG. 9 shows the frame fully open. Note that FIGS. 4-9 depict the support frame in an inverted orientation.

FIGS. 10 and 11 show a close-up perspective view of an example coupling mechanism and locking mechanism, the locking mechanism in this example being a locking pin for inserting through a portion of a frame according to the invention, and the coupling mechanism being a pin, rivet, shaft, or other like device passing through two loops or through a loop and the U-shaped member and having a cap or other structural feature that secures the pin so as to provide a durable and rotatable connection. The locking pin has spring-loaded transverse bodies that resist removal of the locking pin once it has been inserted.

FIG. 12 shows a perspective view of a support frame according to the invention.

FIGS. 13 shows a perspective view of an alternative embodiment of the invention in which a pet enclosure is mounted to a wagon with storage capacity below the enclosure.

FIGS. 14-19 show perspective views of an alternative embodiment of the invention including a canopy for shading a portion of the pet enclosure.

FIG. 20 shows an alterative embodiment of a pet enclosure packed into a case for transport or storage.

### DETAILED DESCRIPTION OF THE INVENTION

An example of a pet enclosure according to the invention comprises a mesh affixed to a foldable support frame. The foldable support frame comprises four rectangular loops and a U-shaped member joined so that they may be folded into a position in which the rectangular loops lie generally in a stacked or parallel relation, as shown in FIGS. 4, 7, and 12. The loops may then be rotated into a generally perpendicular relation and locked into position to form a pet enclosure. Note that loops with shapes other than rectangular may be used, but rectangular loops have been found convenient in practice. In practice a height of about 0.61 m (2 feet), a width of about 0.76 m (2.5 feet), and an overall enclosure length of about 1.67 m (5.5 feet) have proven convenient.

In one embodiment, pet enclosure 100 comprises U-shaped member 30, which has transverse end pieces 36 and 37 formed integrally therewith. Alternatively, the end pieces may be fixedly attached to U-shaped member 30. U-shaped member 30 is rotatably coupled to first rectangular loop 10 by a first coupling mechanism, which in this example comprises pin 38 passing through transverse end piece 36 and first rectangular loop 10, with a similar mechanism on the opposite side at transverse end piece 37. U-shaped member 30 is rotatably coupled to second rectangular loop 20 by a second coupling mechanism, which in this example comprises pin 38 passing through transverse end piece 36 and second rectangular loop 20, with a similar pin on the opposite side at transverse end piece 37. Note that U-shaped member could be altered by adding a crosspiece to make it a closed loop. During assembly by a user, once U-shaped member 20 and rectangular loops 10 and 20 are in their proper orientation, with loops 10 and 20 generally flat on the ground or other support surface, and U-shaped member standing generally vertically, with transverse end pieces 36 and 37 also on or near the support surface, then a locking pin may be used to prevent rotation at each joint between U-shaped member 30 and rectangular loop 10, and between U-shaped member 30 and rectangular loop 20, by passing a locking pin through an aligned aperture in transverse end piece 36 and rectangular loop 10, and by passing a second locking pin through an aligned aperture in transverse end piece 36 and rectangular loop 20. Locking pins may be used to secure first rectangular loop 10 and second rectangular loop 20 to transverse end piece 37.

The exemplary embodiment further comprises third rectangular loop 40 rotatably coupled to second rectangular loop 20 generally opposite the location where second rectangular loop 20 is coupled to U-shaped member 30. The coupling before third rectangular loop 40 and second rectangular loop 20 may be accomplished by use of any suitable coupling mechanisms; and locking may be achieved by any suitable locking mechanism, including the following: a locking mechanism may include a pair of small plates fixed to one loop of a pair of loops to be rotatably attached, with each plate having a pin passing through both the plate and a portion of the second loop in the pair of loops to be coupled. Optionally each locking pin may have a spring-loaded transverse locking aid and a ring to facilitate handling and removal of the pin.

Finally, the exemplary embodiment may comprise fourth rectangular loop 50, coupled and locked to first rectangular loop 10 in the same fashion as third rectangular loop 40 is coupled and locked to second rectangular loop 20.

These four rectangular loops, four coupling mechanisms, and four locking mechanisms are sufficient to create a foldable frame according to the invention. The example of a pet enclosure includes a mesh attached to the frame so that, when the frame is opened and locked into its open configuration, the space defined by the frame and enclosed by the mesh is suitable for enclosing a pet. The mesh should have sufficient flexibility or excess material or both to allow the frame to be folded and unfolded with the mesh attached.

The rectangular loops and the U-shaped member may be constructed from any material of sufficient strength and rigidity to support the mesh. Preferably the rectangular loops are constructed of a lightweight metal tubular members. The mesh preferably is a sturdy, flexible mesh, preferably one that is relatively open.

Optionally, an example pet enclosure according to the invention may include a fifth coupling mechanism positioned to permit the attachment of a sixth rectangular loop having its own mesh to an edge of the fifth rectangular loop such that the sixth rectangular loop may be positioned so as to close and open the opening firmed by the fifth rectangular loop. This sixth rectangular loop effectively provides a door that may be opened to admit a pet into the enclosure and then closed and secured when the pet is inside. The securing function may be performed by a latch, strap, magnet, or other suitable item. If the enclosure does not use the sixth loop, the mesh may be adapted with a securable opening, for example a flap with a zipper, through which a pet may be admitted into the enclosure.

Optionally, a pet enclosure according to the invention may comprise a sun shade; the sun shade may comprise a foldable shade supported by a frame and attached to the device. Preferably the sun shade may be a foldable fabric element that is supportable by a frame that is attachable to the frame of the device. Preferably the sun shade may compromise a pair of frame end pieces, each end preferably being a rod or tube structure with first end, a peak, and a second end. The support frame of the pet enclosure optionally includes on one of the vertically standing loops a pair of receptacles for the first end and second end of a first frame end piece. The support frame of the pet enclosure further comprises on a second one of the vertically standing loops a second pair of receptacles for receiving the first end and the second end of the second frame end piece. Finally, near the peak of the first end piece and the second end piece, each shade frame end piece includes a coupling for a cross member. The cross member is connected to each coupling and extends generally from said first shade frame end piece to said second shade frame end piece for supporting a fabric sun shade. Each frame end piece may connect to the frame of the device by means a receiver; alternatively, the sun shade may be a simple light-blocking body or piece or fabric that may placed atop the enclosure.

While the invention has been described by illustrative embodiments, additional advantages and modifications will occur to those skilled in the art. Therefore, the invention in its broader aspects is not limited to specific details shown and described herein. Optionally a mechanism such as a latch, magnet, strap, other suitable device may be provided to secure the frame in a closed position for storage or transport. Modifications, for example, different couplings such as hinges, different locking mechanisms such as deformable loops, different meshes, and different frame materials may be made without departing from the spirit and scope of the invention. It should be noted that, while a device having rectangular loops is a preferred embodiment, other shapes of loops may be used. Optionally, a pet enclosure according to the invention may comprise a sun shade; the sun shade may comprise a foldable shade supported by a frame and attached to the device; alternatively, the sun shade may be a simple light-blocking body or piece or fabric that may placed atop the enclosure. Accordingly, it is intended that the invention not be limited to the specific illustrative embodiments, but be interpreted within the full spirit and scope of the appended claims and their equivalents.

We claim:

1. A pet enclosure comprising
a mesh affixed to a foldable frame, the foldable frame comprising
a first rectangular loop having a top edge, a left edge, a bottom edge, and a right edge, said bottom edge having a left and a right end;
a first coupling mechanism positioned to permit the attachment of a second rectangular loop to the bottom edge of the first rectangular loop;
a second rectangular loop rotatably attached via the first coupling mechanism along a first edge thereof to the bottom edge of the first rectangular loop;
a second coupling mechanism positioned to permit the attachment of a third rectangular loop to the bottom edge of the first rectangular loop;
a third rectangular loop rotatably attached along a first edge thereof to the bottom edge of the first rectangular loop;
a third coupling mechanism positioned to permit the attachment of a fourth rectangular loop to the edge of the second rectangular loop opposite the edge along which the second rectangular loop is attached to the first rectangular loop;
a fourth rectangular loop rotatably attached to the second rectangular loop along the edge opposite the edge along which the second rectangular loop is attached to the first rectangular loop;
a fourth coupling mechanism positioned to permit the attachment of a fifth rectangular loop to the edge of the first rectangular loop opposite the edge along which the third rectangular loop is attached to the first rectangular loop;
a fifth rectangular loop rotatably attached to the first rectangular loop along the edge opposite the edge along which the third rectangular loop is attached to the first rectangular loop;
a first locking mechanism adapted to prevent rotation between the first rectangular loop and the second rectangular loop;
a second locking mechanism adapted to prevent rotation between the first rectangular loop and the third rectangular loop;
a third locking mechanism adapted to prevent rotation between the second rectangular loop and the fourth rectangular loop;
a fourth locking mechanism adapted to prevent rotation between the first rectangular loop and the fifth rectangular loop;
wherein the mesh is attachable to the foldable frame to create a pet enclosure in the space defined by said frame, and wherein the foldable frame may be locked in an open position so that the frame and mesh define a pet enclosure, and wherein the mesh has a closable opening therein.

2. A pet enclosure according to claim 1, further comprising:
a fifth coupling mechanism positioned to permit the attachment of a sixth rectangular loop to an edge of the fifth rectangular loop such that the sixth rectangular loop may be positioned so as to close and open the opening formed by the fifth rectangular loop;
a sixth rectangular loop configured to close and open the opening formed by the fifth rectangular loop, the sixth loop being attached to the fifth rectangular loop so as to close and open the opening formed by the fifth rectangular loop; and
a locking mechanism to secure the sixth rectangular loop in a closed position with respect to the fifth rectangular loop.

3. A pet enclosure according to claim 3, further comprising:
a sixth coupling mechanism positioned to permit the attachment of a seventh rectangular loop to an edge of the fourth rectangular loop such that the seventh rectangular loop may be positioned so as to close and open the opening formed by the fourth rectangular loop;
a seventh rectangular loop configured to close and open the opening formed by the fourth rectangular loop, the seventh loop being attached to the fourth rectangular loop so as to close and open the opening formed by the fourth rectangular loop; and
a locking mechanism to secure the seventh rectangular loop in a closed position with respect to the fourth rectangular loop.

4. A modular pet enclosure system, comprising:
a first pet enclosure according to claim 2;
a second pet enclosure according to claim 2, the sixth loop of said first pet enclosure, and the sixth loop of said second pet enclosure, both being placed in an open position; and
said first pet enclosure and said second pet enclosure being positioned so that the opening formed by the fifth loop of said first pet enclosure and the fifth loop of said second pet enclosure are positioned immediately adjacent one another to permit a pet to move from said first pet enclosure into said second pet enclosure to form a modular pet enclosure.

5. A modular pet enclosure system, comprising:
a first pet enclosure according to claim 2;
a second pet enclosure according to claim 3, the sixth loop of said first pet enclosure, and the sixth loop of said second pet enclosure, both being placed in an open position; and
said first pet enclosure and said second pet enclosure being positioned so that the opening formed by the fifth loop of said first pet enclosure and the fifth loop of said second pet enclosure are positioned immediately adjacent one another to permit a pet to move from said first pet enclosure into said second pet enclosure to form a modular pet enclosure.
